(19) United States
(12) Patent Application Publication
(10) Pub. No.: US 2004/0126744 A1
(43) Pub. Date: Jul. 1, 2004

(54) Kid learning instrument with rotating wheels

(76) Inventor: Dale Chang, Taipei City (TW)

Correspondence Address: Dale CHANG, P.O Box No. 6-57, Chung-Ho, Taipei, 235, TW

(21) Appl. No.: 10/330,224

(22) Filed: Dec. 30, 2002

(51) Int. Cl. G09B 1/00

(52) U.S. Cl. 434/167

(57) ABSTRACT

A kid learning instrument with rotating wheels has a plurality of operation rotating wheels and a control rotating wheel inserted on a post-shaped main body; a plurality of different figures or words are annularly disposed on external surfaces of the operation rotating wheels and the control rotating wheel; the main body is disposed with a battery chamber, a circuit board, a speaker and an operation switch; turning the control rotating wheel to a certain position, a kid rotates the operation rotating wheels to select or match the figures or words disposed thereon and activates an operation switch inside the main body to enable a speaker to make certain set sounds according to different matching situations so as to provide multiple variations and audio-visual connections for achieving a learning effect.

### BACKGROUND OF THE INVENTION

1) Field of the Invention

The present invention relates to a kid learning instrument with rotating wheels having a plurality of rotary operation rotating wheels and a control rotating wheel inserted on a post-shaped main body; a plurality of different figures or words are annularly disposed on external surfaces of the operation rotating wheels and the control rotating wheel; a kid rotates the operation rotating wheels to select or match the figures or words thereon to enable a speaker to make certain set sounds according to different matching situations so as to provide multiple variations and audio-visual connections for achieving a learning effect.

2) Description of the Prior Art

Accordingly, along with the change of social environment, people more concern child education and important issues of providing attractive instruments with enriched learning effect for them; relative designers and manufacturers endeavor to develop various kinds of instruments to meet the market demands.

Although many kinds of learning instrument are available on the market, the achieved effect is not outstanding due to the difference of designing concepts. The most popular learning instrument is the audible book which makes sound or emits light when a kid turns the pages or touches a certain press button; however, the variation thereof is very limited. Other toys are designed to allow the kid to select colors, shapes, alphabets or numbers; a correct selection causes the instrument to make clapping or hurrahing sound while a mistake makes an error indicating sound. With the limited variation in designing, the kid usually figures out the tricks to play it within three to five days thus loosing interest in trying again and that reduces the existing value of the learning instrument. More particularly, to the kid, instruments require pushing press buttons are very boring, such as tapping on a computer keyboard. After all, the touching sense of the kid at developing stage is completely different from the adult's and that's why, to kids, all kinds of building blocks and play dolls are more attractive than paper and pens.

To the child educators, the most challenging research topic is how to provide an instrument that can help kids continuously make progress, have many variations for preventing boredom within a short period of time and the design capable of providing staged learning effect.

In view of the designs of the available kid learning instruments failing to meet the demands of parents, teachers and children, the inventor of the present invention researched and developed an advanced and practical kid learning instrument with rotating wheels.

### SUMMARY OF THE INVENTION

The primary objective of the present invention is to provide a kid learning instrument with rotating wheels having a plurality of rotary operation rotating wheels and a control rotating wheel inserted on a post-shaped main body; a plurality of different figures or words are annularly disposed on external surfaces of the operation rotating wheels and the control rotating wheel; the main body is disposed with a battery chamber, a circuit board, a speaker and an operation switch; a kid rotates the operation rotating wheels to select or match the figures or words thereon to activate an operation switch thereby enabling a speaker to make certain set sounds according to different matching situations; controlling the operation rotating wheels selects different applications and matching methods thereby providing multiple variations and audio-visual connections for achieving a learning effect.

Another objective of the present invention is to provide a kid learning instrument with rotating wheels having a plurality of rotary operation rotating wheels inserted on the main body; the kid rotates the operation rotating wheels to select or match the figures or words disposed thereon thereby training the wrist and finger movements so as to achieve a learning effect of eye-hand coordination.

To enable a further understanding of achieving the abovementioned objectives the structural features of the present invention, the brief description of the drawings is followed by the detailed description of a preferred embodiment.

### BRIEF DESCRIPTION OF THE DRAWINGS

FIG. 1 is a pictorial drawing of the present invention.

FIG. 2 is a pictorial and exploded drawing of the present invention.

FIG. 3 is a cross-sectional drawing of the assembly of the present invention.

FIG. 4 is a radial, cross-sectional and schematic drawing of the cooperation between an operation rotating wheel and an operation switch of the present invention.

FIG. 5 is a radial, cross-sectional and schematic drawing of the cooperation between a control rotating wheel and a positioning elastic tab of the present invention.

FIG. 6 is the first schematic drawing of a selection ring of the control rotating wheel deflecting at different angles for conducting different controlling circuits.

FIG. 7 is the second schematic drawing of the selection ring of the control rotating wheel deflecting at different angles for conducting different controlling circuits.

### DETAILED DESCRIPTION OF THE PREFERRED EMBODIMENTS

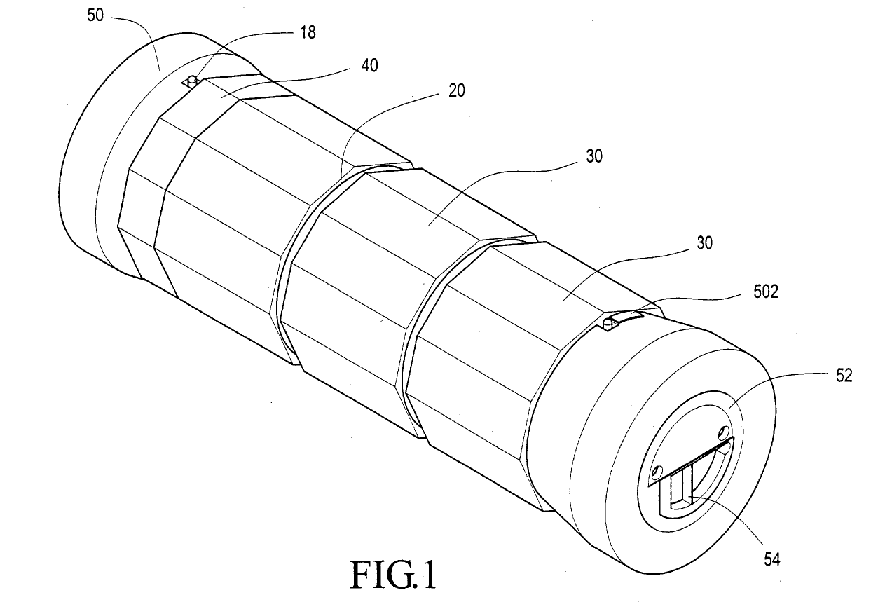

FIG. 1 shows an external view drawing of a preferred embodiment of the present invention; wherein, the present invention of a kid learning instrument with rotating wheels is approximately in a cylindrical type with an end cover (50) respectively disposed at two ends of the instrument; a plurality of operation rotating wheels (30) are disposed between the two end covers (50); the external surface of the operation rotating wheel (30) has a plurality of planes disposed with different figures or words thereon.

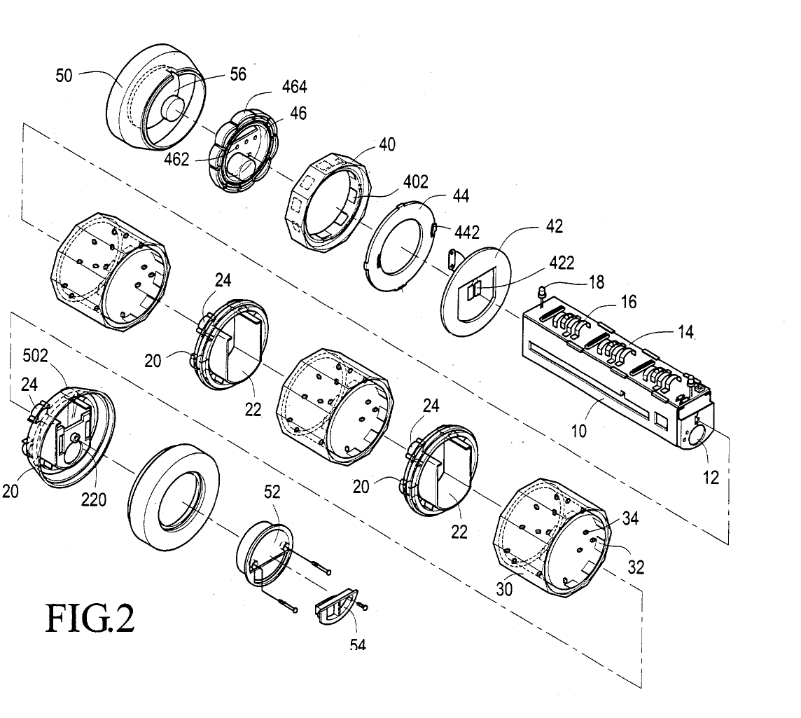

FIG. 2 shows the exploded and schematic drawing of the elements of the present invention; a post-shaped main body (10) is disposed with a battery chamber (12), a circuit board (14), an operation switch (16) and an indicating light (18) at a proper position thereof.

A plurality of fixing rings (20) insert on the post-shaped main body (10); a fixing insert (22) to be inserted on the post-shaped main body (10) is disposed on the inner lateral side of the fixing ring (20); one lateral side of the fixing ring (20) forms a positioning elastic tab (24); wherein an end plate (220) is disposed on the inner lateral side of the fixing ring (20) disposed adjacent to the end portion of the post-shaped main body (10) for assembling said fixing ring (20) onto the post-shaped main body (10).

The operation rotating wheels (30) insert in intervals on the post-shaped main body (10) and the fixing ring (20); a positioning arc slot (32) is disposed on the inner lateral side of the operation rotating wheel (30) to fit with a positioning elastic tab (24) of the fixing ring (20); a driving structure (34) of the operation switch (16) for contacting the post-shaped main body (10) is disposed on the inner lateral side of the operation rotating wheel (30).

A control rotating wheel (40) inserts at one end area of the post-shaped main body (10); a positioning arc slot (402) is disposed on the inner lateral side of the control rotating wheel (40); a control circuit board (42), a selection ring (44) and a positioning ring (46) are disposed inside the control rotating wheel (40).

Wherein, the control circuit board (42) inserts fixedly on the post-shaped main body (10) and outwardly extends a power line (422) to connect with the circuit board (14) of the post-shaped main body (10) for conducting electricity.

The selection ring (44) is fixedly disposed on the inner lateral side of the control rotating wheel (40) and has a conduction tab (442) disposed thereon to contact the control circuit board (42).

A positioning elastic tab (464) is formed on the outer circumference of the positioning ring (46) to fit with the positioning arc slot (402) of the control rotating wheel (40).

An end cover (50) is respectively disposed at two ends of the post-shaped main body (10); an input button (502) is disposed at a proper position on one of the end covers (50); a small end cover (52) is disposed on the end plane of the other end cover (50); a battery cover (54) to be opened by a user is disposed on the small end cover (52) for assembling or replacing the battery (not shown) in the battery chamber (12); a speaker (56) is assembled inside the other end cover (50).

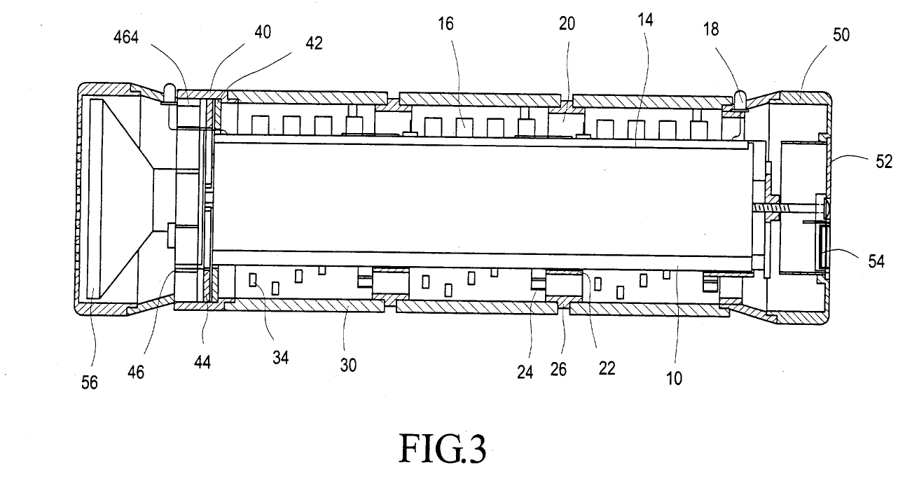

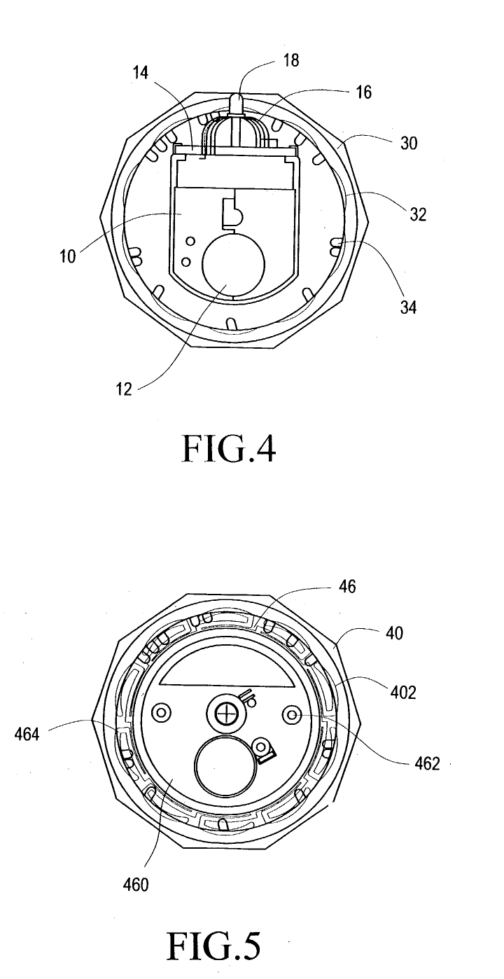

Referring to FIG. 3, a plurality of operation rotating wheels (30) and a control rotating wheel (40) insert on the post-shaped main body (10) to fit with the fixing ring (20; they are clamped to positions by the end covers (50) at two ends; wherein the fixing ring (20) and the end covers (50) are fixedly disposed on the post-shaped main body (10); two ends of the operation rotating wheel (30) are respectively mounted on the positioning elastic tab (24) of the fixing ring (20) for the user to rotate and operate; the cooperation between the positioning elastic tab (24) and the positioning arc slot (32) allows the operation rotating wheel (30) to provide a desired touch at every position and a simpler operation. Referring to FIG. 4, when the operation rotating wheel (30) rotates in operation, the driving structure (34) disposed on the inner lateral side of the operation rotating wheel (30) activates different operation switches (16) disposed on the post-shaped main body (10); the proper position of the driving structure (34) disposed on the inner lateral side of the operation rotating wheel (30) activates different operation switches (16) when the operation rotating wheel (30) rotates to different angles; it also causes short circuit on the circuit board (14) thereby providing various touch-control selections.

As indicated in the Figures, the external surfaces of the operation rotating wheels (30) has the contours of polygons; that means, the external surfaces of the operation rotating wheels (30) form a plurality of planes. Therefore, a plurality of figures or words are disposed on the external surfaces of the operation rotating wheels (30). The battery chamber (12) is disposed in the post-shaped main body (10) for installing batteries; the circuit board (14) along with the operation switch (16) and the indicating light (18) disposed thereon fit with an input button (502) through a proper circuit arrangement. The speaker (56) assembled in one of the end covers (50) also connects with the circuit board (14). When rotating the operation rotating wheels (30) to select and match the specific positions of the figures or words disposed thereon, the kid presses the input button (502) downwardly. The driving structure (34) inside the operation rotating wheels (30) activates different operation switches (16) inside the post-shaped main body (10) to enable the pressed input button (502) to conduct the electricity thereby turning on a specific indicating light (18) according to different matching situations; for example, the green light is on for a correct match and the red light is on for an error. At the same time, the speaker (56) makes a certain sound, such as clapping or booing sound, pronouncing certain vocabulary or expression for providing multiple variations or audio-visual connections to achieve learning effect.

The control rotating wheel (40) disposed in the present invention provides another selection function. FIG. 5 shows the radial, cross sectional and schematic drawing of the cooperation between the control rotating wheel (40) and the positioning elastic tab (464) of a preferred embodiment of the present invention. With the exploded drawing of FIG. 2, they show the cooperation status between the positioning arc slot (402) on the inner lateral side of the control rotating wheel (40) and the positioning elastic tab (464) of the positioning ring (46). It is obvious that the number of the positioning elastic tab (464) fitting with the positioning arc slot (40) on the inner lateral side of the control rotating wheel (40) is more than that of the positioning elastic tab (24) fitting with the positioning arc slot (32) of the operation rotating wheel (30). As indicated in FIGS. 1 and 2, the external area of the control rotating wheel (40) is smaller than that of the operation rotating wheel (30) such that to rotate and adjust the control rotating wheel (40) is more difficult than to rotate and adjust the operation rotating wheel (30). Therefore, it is necessary to exert more force for rotating the control rotating wheel (40) and that prevents error movement in application; that means, rotating the operation rotating wheel (30) prevents the user from easily driving the control rotating wheel (40) to rotate thereby assuring the steadiness in operating the present invention.

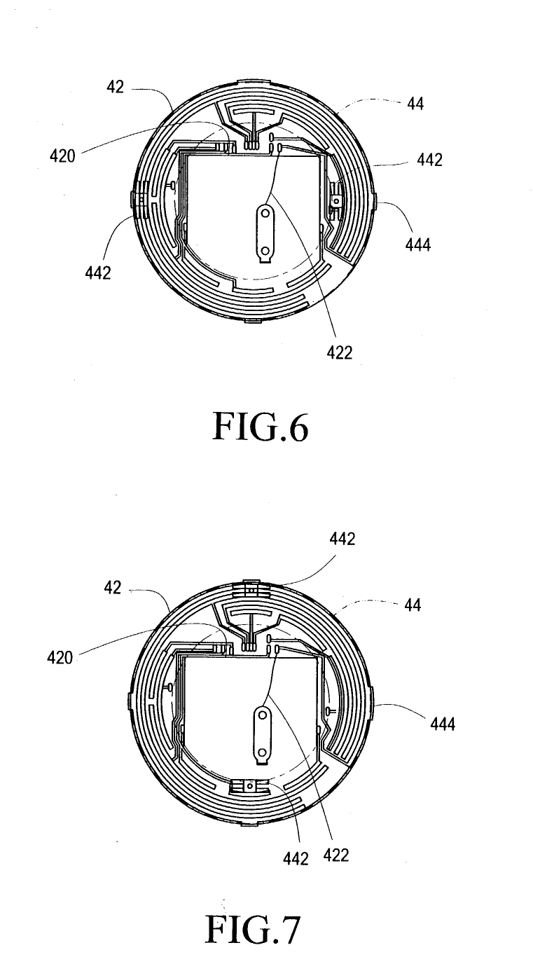

FIGS. 6 and 7 show the schematic drawings of the selection ring (44) in the control rotating wheel (40) conducting different control circuits at different angles in a preferred embodiment of the present invention. Viewing these two Figures makes it obviously that the circuit status disposed on the control circuit board (42) on the lateral sides of the control rotating wheel (40) has two annular power supply circuits disposed adjacent to the outer rim area on one plane of the control circuit board (42). Two circles of annularly arranged multi-segmented functional selection circuits are disposed on the inner lateral sides of the power supply circuit. When the selection ring (44) affixes to one side thereof, one of the conduction tabs (442) on the selection ring (44) conducts two power supply circuits; the other conduction tab (442) conducts the functional selection circuits such that the control rotating wheel (40) drives the selection ring (44) to rotate and conduct the conduction tab (442) of the functional selection circuits to conduct the functional conduction circuit with different functions so as to achieve the effect of changing the learning items. A section of notches are disposed on the power conduction circuit disposed annularly; when the conduction tab (442) on the selection ring (44) for conducting the circuit is driven by the control rotating wheel (40) to drive and rotate to the position, it breaks the power source and turns off the machine.

As indicated in the embodiment, three operation rotating wheels (30) are disposed and each of them has ten planes; that makes 10×10×10=1000 kinds of arrangements and combinations. In addition, the control rotating wheel (40) has ten selections; together, they make ten thousand arrangements and combinations. If it is necessary, the number of the operation rotating wheels (30) and the control rotating wheel (40) can be increased to expand the variation of the present invention.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A kid learning instrument with rotating wheels comprises a plurality of operation rotating wheels inserted on a post-shaped main body; a plurality of different figures or words are annularly disposed on external surfaces of the operation rotating wheels; the post-shaped main body is disposed with a battery chamber, a circuit board and a speaker; an operation switch is disposed on the circuit board; a driving structure is disposed on the inner lateral side of the operation rotating wheel for activating the operation switch of the circuit board; rotating the operation rotating wheels to select or match the figures or words thereon and activating the operation switch on the circuit board cause a speaker to make certain set sounds according to the match of different operation rotating wheels so as to provide multiple variations and audio-visual connections for achieving a learning effect.

2. The kid learning instrument with rotating wheels according to claim 1, wherein the external surfaces of the operation rotating wheels have a plurality of planes disposed with different figures and words.

3. The kid learning instrument with rotating wheels according to claim 1, wherein a plurality of fixing rings insert on the post-shaped main body; a fixing insert is disposed on the inner lateral side of the fixing ring and inserted on the post-shaped main body to make the operation rotating wheels respectively insert between the fixing rings.

4. The kid learning instrument with rotating wheels according to claim 3, wherein a positioning elastic tab is formed on the fixing ring to correspond to a positioning arc slot disposed on the inner lateral side of the operation rotating wheel.

5. The kid learning instrument with rotating wheels according to claim 3, wherein an end plate is disposed on the inner lateral side of the fixing ring adjacent to the end portion of the post-shaped main body so as to assemble said fixing ring onto the post-shaped main body via the end plate.

6. The kid learning instrument with rotating wheels according to claim 1, wherein one end of the post-shaped main body is disposed with a control rotating wheel having a selection ring installed therein; the selection ring has a conduction tab; one end of the post-shaped main body is fixedly disposed with a control circuit board having a functional selection circuit connecting with the circuit board of the post-shaped main body; the conduction tab of the selection ring affixes onto the functional selection circuit of the control circuit board for conducting such that rotating the control rotating wheel makes the conduction tab of the selection ring lean against the functional selection circuit of the control circuit board to conduct and switch to different functions.

7. The kid learning instrument with rotating wheels according to claim 6, wherein the inner lateral side of the control rotating wheel forms a positioning arc slot; a positioning ring is disposed inside the control rotating wheel; the outer periphery of the positioning ring forms a positioning elastic tab to correspond to the positioning arc slot of the control rotating wheel.

8. The kid learning instrument with rotating wheels according to claim 1, wherein an indicating light is disposed on the circuit board of the post-shaped main body.
